(19) United States
(12) Patent Application Publication
(10) Pub. No.: US 2026/0367639 A1
(43) Pub. Date: Nov. 19, 2026

(54) System And Method For Motion Control Of Unmanned Aerial Vehicles

(71) Applicant: The Hong Kong Polytechnic University, Hunghom (HK)

(72) Inventors: Weisong WEN, Hung Hom (HK); Peiwen YANG, Hung Hom (HK)

(73) Assignee: The Hong Kong Polytechnic University, Hunghom (HK)

(21) Appl. No.: 19/185,610

(22) Filed: Apr. 22, 2025

Related U.S. Application Data
(60) Provisional application No. 63/709,072, filed on Oct. 18, 2024.

(51) Int. Cl. G05D 1/644; B64U 10/14; B64U 20/80; G05D 1/242; G05D 1/245; G05D 1/248; G05D 109/25; G08G 5/30; G08G 5/57

(52) U.S. Cl. CPC G05D 1/644; B64U 10/14; B64U 20/80; G05D 1/242; G05D 1/245; G05D 1/248; G08G 5/30; G08G 5/57; B64U 2201/104; G05D 2109/254

(57) ABSTRACT

This patent application discloses a method and system for real-time control of an unmanned aerial vehicle (UAV) through joint optimization of positioning and control. The method involves receiving sensor measurements from onboard sensors and constructing a unified probabilistic factor graph that integrates positioning-related factors derived from the sensor data and control-related factors generated by a model predictive control (MPC) framework. The positioning factors account for spatial state estimation, while the control factors encode dynamic constraints and trajectory objectives. The unified factor graph is solved iteratively using factor graph optimization (FGO), enabling simultaneous optimization of the UAV's state estimation and control inputs in a single computational framework. This integrated approach reduces positional tracking errors and minimizes orientation oscillations during flight, enhancing stability and precision. The system operates in real-time on multi-rotor UAVs. Key advantages include improved trajectory tracking accuracy, robustness to sensor noise, and reduced mechanical vibrations caused by orientation fluctuations.

### CROSS-REFERENCE TO RELATED APPLICATIONS

This application claims the benefit of U.S. Provisional Patent Application No. 63/709,072, filed on Oct. 18, 2024, which is incorporated by reference herein in its entirety.

### PRIOR DISCLOSURES BY THE INVENTORS OR JOINT INVENTORS

Part of the present invention was also disclosed in a paper submitted to the arXiv preprint, arXiv:2404.14724 on Apr. 23 2024. This paper is a grace period inventor-originated disclosure disclosed within one year before the effective filing date of this application. A copy of the article is provided on the Information Disclosure Statement.

LIST OF SYMBOLS

| Symbol | Remarks |
|---|---|
| ω^{×} (ω) = [ω₁, ω₂, ω₃]^{T}) | ${ω}^{\times } = [ \begin{matrix}0 & - {ω}_{3} & {ω}_{2} \\ {ω}_{3} & 0 & - {ω}_{1} \\ - {ω}_{2} & {ω}_{1} & 0\end{matrix} ]$ |
| x = [p^{T}, θ^{T}, v^{T}, ω^{T}]^{T} | State x, position p, rotation R = |
| | exp(θ^{×}), velocity v, and |
| | angular speed ω |
| \hat{x} | Optimized state |
| Δx | State increment w.r.t initial |
| | state |
| δx | State increment in the tangent |
| | space |
| z | Sensor observation |
| u | Control input |
| z^{r}, u^{r} | Reference state and reference |
| | input |
| T, M | Resultant thrust T and |
| | resultant torque M |
| P | Covariance matrix |
| K | Control law |
| D | Aerodynamic drag coefficient |
| | matrix |
| I_{b} | Moment of inertia |
| g | Gravity constant |
| m_{b} | UAV’s mass |
| cₜ | Rotor’s aerodynamic thrust |
| | coefficient |
| kₘ | Rotor’s aerodynamic torque |
| | coefficient |
| ${p}_{{r}_{j}}^{b}$ | j-th rotor’s position in the body frame |
| ${T}_{{b}_{l}}^{w}$ | UAV's pose in the world frame at timestamp l |
| ${T}_{l + 1}^{l} , {P}_{l}^{L}$ | Relative pose transformation from timestamp l to timestamp |
| | l + 1 and its covariance matrix |
| r^{R}, r^{A}, r^{ref} | Relative factor residuals, |
| r^{D}, h(uⱼ), r^{U} | absolute factor residuals, |
| | reference trajectory factor |
| | residuals, dynamic control |
| | factor residuals, control bound |
| | factor residuals, and control |
| | rate factor residuals |
| Qₖ, Q_{N}, Rₜ, Qₗᵢₘ | Weighting matrix in MPC; |
| | covariance matrix in JPCM |
| Iₙ | n-dimensional unit vector |

### FIELD OF THE INVENTION

The present invention relates to autonomous systems, and more particularly to a system and method for motion control of unmanned aerial vehicles (UAVs).

### BACKGROUND OF THE INVENTION

The execution of flight missions by unmanned aerial vehicles (UAV) predominantly relies on motion control. Reliable motion control is of great significance for the applications of unmanned aerial vehicles (UAV). Typically, the motion control pipeline has traditionally been divided into positioning and control, operating in a sequential loop. The model-based motion control method has a fixed loop: estimating state and then deriving control. As illustrated in FIG. 1, the classical motion control framework's pipeline runs in cycles, first by estimating the state and then deriving a control input u_opt based on MPC. The state estimation can be achieved using sensors, such as the global navigation satellite system (GNSS) receivers, inertial measurement unit (IMU), or a light detection and ranging (LiDAR) sensors. Then the state estimation from the positioning module is fed to the controller of the UAV, such as the popular model predictive control (MPC). The positioning module and control module are decoupled. The pipeline of decoupling positioning and control has dominated the practice of UAV for decades.

However, such existing control pipelines are limited in terms of reasoning about sources of epistemic uncertainty (e.g. uncertain disturbances) and aleatoric uncertainty (e.g. measurement's randomness), and nonlinear dynamics. The existing motion control pipeline, where the positioning and control are decoupled, struggles to adapt to epistemic and aleatoric uncertainty, and nonlinear dynamics. As a result, the motion control reliability of the UAV is significantly challenged in complex dynamic areas. For example, the ubiquitous global navigation satellite system (GNSS) positioning can be degraded by the signal reflections from surrounding high-rising buildings in complex urban areas, leading to significantly increased positioning uncertainty. An additional challenge is introduced to the control algorithm due to the complex wind disturbances in urban canyons.

Another challenge is positioning solutions having large uncertainty in complex scenes. In particular, the positioning can be derived from the state estimator, such as the Kalman filter or factor graph optimization (FGO) based on the onboard sensors. For example, GNSS was widely used in vehicular localization under open sky and usually combined with proprioceptive sensors such as inertial measurement unit (IMU) and exteroceptive sensors such as light detection and ranging (LiDAR) during satellite signal outages. However, the performance of these solutions relies strongly on the environmental conditions. On the one hand, the GNSS positioning can be significantly degraded in urban canyons due to the multipath effects caused by the signal reflections from high-rise buildings. Although numerous works were proposed to mitigate the impacts of the GNSS outliers, the positioning solution derived from the GNSS is still unreliable in highly urbanized areas with significant uncertainty. Moreover, the LiDAR-based positioning can also be significantly challenged in urban canyons due to the excessive dynamic objects, leading to unacceptable positioning uncertainty for control system.

In addition, insufficient awareness of the positioning uncertainty can challenge the controllers in complex scenes. Usually, the positioning solution is directly fed to the controller, such as the PID controller, assuming a perfect positioning accuracy is guaranteed. Unfortunately, positioning accuracy is usually not guaranteed in complex scenes using the existing GNSS or multi-sensory integration. As a result, the controller would inevitably lead to non-optimal control commands, therefore causing dangerous UAV actions. Hence, the control stability under large positioning uncertainty is essential for safety. The traditional control methods struggle to simultaneously deal with the uncertainty of state, obstacles, and nonlinear dynamics in the context of decoupling the positioning and control modules. Instead of carefully coping with the uncertainty arising from the positioning module, the existing work mainly focuses on the disturbances of the dynamical model, while ignoring the uncertainties of raw measurements. However, it is difficult to reliably distinguish the positioning uncertainty and the exact disturbance coming from the surrounding environments. To consider the uncertainty of the positioning module, a solution is to directly add the positioning uncertainty as the covariance matrix of the cost function in the MPC. However, this solution has several key drawbacks: (1) it relied heavily on the reliability of the uncertainty provided by the positioning module, which is hard to obtain in complex scenes as mentioned above; and (2) the information from the controller cannot flow back to the positioning modules.

As such, there is a need for a motion control solution for UAV which could address at least one of the above-mentioned technical problems.

### SUMMARY OF THE INVENTION

The present application proposes a tightly joined positioning and control model (JPCM) that unifies the positioning and control under the same mathematics representation. Therefore, the primary aim is to tightly formulate a unified problem of positioning and control for unmanned aerial vehicles (UAVs) by integrating sensor data and dynamic constraints into a single probabilistic graph.

According to a first aspect of the present application, there is provided a method for controlling an unmanned aerial vehicle (UAV), comprising: receiving sensor measurements from one or more sensors; constructing a unified probabilistic factor graph by integrating positioning-related factors derived from the sensor measurements and control-related factors derived from a model predictive control (MPC); solving the unified probabilistic factor graph using factor graph optimization (FGO) to jointly optimize positioning and control of the UAV; and generating control inputs for the UAV based on the optimized positioning and control.

In a preferred embodiment, the positioning-related factors include absolute factors constraining a state of the UAV at a specific timestamp, and relative factors constraining changes of the state of the UAV between different timestamps, and wherein the state of the UAV includes at least one of the following: position, rotation, attitude, pose, velocity and angular velocity of the UAV.

In a further preferred embodiment, the absolute factors are derived from global navigation satellite system (GNSS) measurements provided by a GNSS receive; and the relative factors are derived from light detection and ranging (LiDAR) scan-matching measurements provided by a LiDAR sensor and/or inertial measurement unit (IMU) measurements provided by an IMU.

In a further preferred or an alternative embodiment, the control-related factors include at least one of the following: dynamic factors converted from dynamics constraints and derived from a UAV dynamic model of UAV dynamics; control bound factors converted from control bound constraints for limiting control inputs; control rate factors converted from control rate constraints for limiting rate of change of control inputs and smoothing control input transitions; and reference trajectory factors converted from trajectory tracking constraints for predicting a state close to a pre-planned trajectory.

In a further preferred embodiment, the method further comprises incorporating aerodynamic drag forces into the dynamic factors by modifying the UAV dynamic model to include a drag coefficient matrix, and residuals of the dynamic factors are adjusted to account for aerodynamic effects. Advantageously, the positioning and the control are linked by the dynamic factors.

In a further preferred embodiment, the method further comprises applying a sliding window to optimize over a historical sequence of states and a predicted sequence of future states. Advantageously, the unified probabilistic factor graph is solved using the FGO to compute maximum a posteriori (MAP) estimates for states and control inputs, using covariance matrices associated with the sensor measurements and dynamic model factors. Preferably, the control inputs are generated by solving the factor graph using a library for Georgia Tech Smoothing and Mapping (GTSAM).

In a further preferred embodiment, the a joint cost function of the unified probabilistic factor graph is represented by below formula:

$${min}_{χ} \{ \begin{matrix}{\sum }_{c = - M + 1}^{0} {‖ {r}_{c}^{A} ‖}_{{P}_{c}^{A}}^{2} + {\sum }_{l = - M + 1}^{- 1} {‖ {r}_{l}^{R} ‖}_{{P}_{l}^{L}}^{2} + {\sum }_{i = 0}^{N - 1} {‖ {r}_{i}^{D} ‖}_{{P}_{i}^{D}}^{2} + \\ {\sum }_{k = 1}^{N} {‖ {r}_{k}^{ref} ‖}_{{Q}_{k}}^{2} + {\sum }_{t = 0}^{N - 2} {‖ {r}_{t}^{U} ‖}_{{R}_{t}}^{2} + {\sum }_{j = 0}^{N - 1} {‖ h ( {u}_{j} ) ‖}_{{Q}_{lim}}^{2}\end{matrix} \}$$

where M is the number of states to be estimated and N is the length of the predicted states,

$${r}_{c}^{A}$$

is residual of absolute factor and

$${r}_{l}^{R}$$

is residual of relative factor,

$${r}_{i}^{D}$$

is residual of dynamic factor, r^{ref} is residual of reference trajectory factor, uⱼ represents the angular speed of the j-th motor of the UAV and h(uⱼ) is residual of control bound factor, and

$${r}_{t}^{U}$$

is residual of control rate factor, and where

$${P}_{i}^{D} , {P}_{c}^{A} , {P}_{l}^{L} {Q}_{k} , {R}_{t} ,$$

and Qₗᵢₘ represent weighting matrices or covariance matrices.

In a further preferred embodiment, the residual of dynamic factor

$${r}_{i}^{D}$$

is derived from below error model:

$${\overline{e}}_{p} = {R}_{w}^{{b}_{i}} {m}_{b} ( {p}_{{b}_{i + 1}}^{w} - {v}_{{b}_{i}}^{w} Δ t + 0.5 {R}_{G}^{w} {e}_{3} g Δ {t}^{2} - {p}_{{b}_{i}}^{w} ) - 0.5 {T}_{{b}_{i}} Δ {t}^{2}$$

$${\overline{e}}_{θ} = Log ( {R}_{w}^{{b}_{i}} {R}_{{b}_{i + 1}}^{w} ) - {ω}_{{b}_{i}} Δ t$$

$${\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t - {DR}_{w}^{{b}_{i}} {v}_{{b}_{i}}^{w} Δ t$$

$${\overline{e}}_{ω} = {I}_{b} ( {ω}_{{b}_{i + 1}} - {ω}_{{b}_{i}} ) - ( {M}_{{b}_{i}} - {ω}_{{b}_{i}} \times {I}_{b} {ω}_{{b}_{i}} ) \cdot Δ t$$

### Where

$${R}_{b}^{w}$$

is rotation of the UAV, m_{b} is mass of the UAV,

$${p}_{b}^{w}$$

is position of the UAV,

$${v}_{b}^{w}$$

is velocity of the UAV, and ω_{b} is angular speed of the UAV, Δt is the period between two contiguous states, Log(*) represent a Logarithmic map of Lie theory, e₃=[0,0,1]^{T}, g is the gravity constant, D is the aerodynamic drag coefficient matrix and

$${ω}_{b}^{\times }$$

represents an operator that spins a 3D vector ω_{b}, T_{b} is resultant thrust, M_{b} is resultant torque, I_{b} is the moment of inertia,

$${R}_{G}^{w}$$

is the gravity vector attitude in the world frame,

$${R}_{w}^{{b}_{i}}$$

is the transpose matrix of

$${R}_{{b}_{i}}^{w} .$$

In a further preferred embodiment, the residual of control bound factor h(uⱼ) is derived from a hinge loss cost function E=h(uⱼ) for the control input inequality, which is as follows:

$${E}_{i} = \{ \begin{matrix}{u}_{min}^{j} + {u}_{thr}^{j} - {u}_{j} ( i ) & if {u}_{j} ( i ) < {u}_{min}^{j} + {u}_{thr}^{j} \\ {u}_{j} ( i ) - {u}_{max}^{j} + {u}_{thr}^{j} & if {u}_{max}^{j} - {u}_{thr}^{j} \leq {u}_{j} ( i ) \\ 0 & otherwise\end{matrix}$$

$$( 1 \leq i \leq K )$$

where

$${u}_{min}^{j}$$

is an input lower bound, and

$${u}_{max}^{j}$$

is an input upper bound, and

$${u}_{thr}^{j}$$

is a threshold value, Qₗᵢₘ is a control bound factor's weighting matrix which determines how fast the error grows as the value approaches the limit, and uⱼ represents the angular speed of the j-th motor of the UAV.

According to the second aspect of the present application, there is provided a system for controlling a UAV comprising: one or more sensors; one or more processors; and one or more memories storing computer-readable instructions that, upon execution by the one or more processors, cause the system to: receive sensor measurements from the one or more sensors, construct a unified probabilistic factor graph by integrating positioning-related factors derived from the sensor measurements and control-related factors derived from a MPC; solve the unified probabilistic factor graph using factor graph optimization (FGO) to jointly optimize positioning and control of the UAV; and generate control inputs for the UAV based on the optimized positioning and control.

In a preferred embodiment, the positioning-related factors include absolute factors constraining a state of the UAV at a specific timestamp, and relative factors constraining changes of the state of the UAV between different timestamps, and wherein the state of the UAV includes at least one of the following: position, rotation, attitude, pose, velocity and angular velocity of the UAV.

In a further preferred embodiment, the absolute factors are derived from GNSS measurements provided by a GNSS receive; and the relative factors are derived from LiDAR scan-matching measurements provided by a LiDAR sensor and/or IMU measurements provided by an IMU.

In a further preferred or an alternative embodiment, the control-related factors include at least one of the following: dynamic factors converted from dynamics constraints and derived from a UAV dynamic model of UAV dynamics; control bound factors converted from control bound constraints for limiting control inputs; control rate factors converted from control rate constraints for limiting rate of change of control inputs and smoothing control input transitions; and reference trajectory factors converted from trajectory tracking constraints for predicting a state close to a pre-planned trajectory.

In a further preferred embodiment, the system further comprises incorporating aerodynamic drag forces into the dynamic factors by modifying the UAV dynamic model to include a drag coefficient matrix, and residuals of the dynamic factors are adjusted to account for aerodynamic effects. Advantageously, the positioning and the control are linked by the dynamic factors.

In a further preferred embodiment, the system further comprises a sliding window applied to optimize over a historical sequence of states and a predicted sequence of future states.

Advantageously, the unified probabilistic factor graph is solved using the FGO to compute MAP estimates for states and control inputs, using covariance matrices associated with the sensor measurements and dynamic model factors.

Preferably, the control inputs are generated by solving the factor graph using a library for GTSAM.

In a further preferred embodiment, a joint cost function of the unified probabilistic factor graph is represented by below formula:

$${min}_{χ} \{ \begin{matrix}{\sum }_{c = - M + 1}^{0} {‖ {r}_{c}^{A} ‖}_{{P}_{c}^{A}}^{2} + {\sum }_{l = - M + 1}^{- 1} {‖ {r}_{l}^{R} ‖}_{{P}_{l}^{L}}^{2} + {\sum }_{i = 0}^{N - 1} {‖ {r}_{i}^{D} ‖}_{{P}_{i}^{D}}^{2} + \\ {\sum }_{k = 1}^{N} {‖ {r}_{k}^{ref} ‖}_{{Q}_{k}}^{2} + {\sum }_{t = 0}^{N - 2} {‖ {r}_{t}^{U} ‖}_{{R}_{t}}^{2} + {\sum }_{j = 0}^{N - 1} {‖ h ( {u}_{j} ) ‖}_{{Q}_{lim}}^{2}\end{matrix} \}$$

where M is the number of states to be estimated and N is the length of the predicted states,

$${r}_{c}^{A}$$

is residual of absolute factor and

$${r}_{l}^{R}$$

is residual of relative factor,

$${r}_{i}^{D}$$

is residual of dynamic factor, r^{ref} is residual of reference trajectory factor, uⱼ represents the angular speed of the j-th motor of the UAV and h(uⱼ) is residual of control bound factor, and

$${r}_{t}^{U}$$

is residual or control rate factor, and
where

$${P}_{i}^{D} , {P}_{c}^{A} , {P}_{l}^{L} {Q}_{k} , {R}_{t} ,$$

and Qₗᵢₘ represent weighting matrices or covariance matrices. In a further preferred embodiment, the residual of dynamic factor

$${r}_{i}^{D}$$

is derived from below error model:

$${\overline{e}}_{p} = {R}_{w}^{{b}_{i}} {m}_{b} ( {p}_{{b}_{i + 1}}^{w} - {v}_{{b}_{i}}^{w} Δ t + 0.5 {R}_{G}^{w} {e}_{3} g Δ {t}^{2} - {p}_{{b}_{i}}^{w} ) - 0.5 {T}_{{b}_{i}} Δ {t}^{2}$$

$${\overline{e}}_{θ} = Log ( {R}_{w}^{{b}_{i}} {R}_{{b}_{i + 1}}^{w} ) - {ω}_{{b}_{i}} Δ t$$

$${\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t - {DR}_{w}^{{b}_{i}} {v}_{{b}_{i}}^{w} Δ t$$

$${\overline{e}}_{ω} = {I}_{b} ( {ω}_{{b}_{i + 1}} - {ω}_{{b}_{i}} ) - ( {M}_{{b}_{i}} - {ω}_{{b}_{i}} \times {I}_{b} {ω}_{{b}_{i}} ) \cdot Δ t$$

### Where

$${R}_{b}^{w}$$

is rotation of the UAV, m_{b} is mass of the UAV,

$${p}_{b}^{w}$$

is position of the UAV,

$${v}_{b}^{w}$$

is velocity of the UAV, and ω_{b} is angular speed of the UAV, Δt is the period between two contiguous states, Log(*) represent a Logarithmic map of Lie theory, e₃=[0,0,1]^{T}, g is the gravity constant, D is the aerodynamic drag coefficient matrix and

$${ω}_{b}^{\times }$$

represents an operator that spins a 3D vector ω_{b}, T_{b} is resultant thrust, M_{b} is resultant torque, Ip is the moment of inertia

$${R}_{G}^{w}$$

is the gravity vector attitude in the world frame,

$${R}_{w}^{{b}_{i}}$$

is the transpose matrix of

$${R}_{{b}_{i}}^{w} .$$

In a further preferred embodiment, the residual of control bound factor h(uⱼ) is derived from a hinge loss cost function E=h(uⱼ) for the control input inequality, which is as follows:

$${E}_{i} = \{ \begin{matrix}{u}_{min}^{j} + {u}_{thr}^{j} - {u}_{j} ( i ) & if {u}_{j} ( i ) < {u}_{min}^{j} + {u}_{thr}^{j} \\ {u}_{j} ( i ) - {u}_{max}^{j} + {u}_{thr}^{j} & if {u}_{max}^{j} - {u}_{thr}^{j} \leq {u}_{j} ( i ) \\ 0 & otherwise\end{matrix}$$

$$( 1 \leq i \leq K )$$

where

$${u}_{min}^{j}$$

is an input lower bound, and

$${u}_{max}^{j}$$

is an input upper bound, and

$${u}_{thr}^{j}$$

is a threshold value, Qₗᵢₘ is a control bound factor's weighting matrix which determines how fast the error grows as the value approaches the limit, and uⱼ represents the angular speed of the j-th motor of the UAV.

According to a third aspect of the present application, there is provided a non-transitory computer-readable medium storing instructions that, when executed by a processor, cause the processor to perform the method of any one of claims 1-12.

According to a fourth aspect of the present application, there is provided a method for controlling a UAV. The method comprises receiving sensor measurements from one or more sensors, including at least one of a global navigation satellite system (GNSS) receiver, an inertial measurement unit (IMU), or a light detection and ranging (LiDAR) sensor. A unified probabilistic factor graph is constructed by integrating positioning-related factors derived from the sensor measurements and control-related factors derived from a model predictive control (MPC). The unified probabilistic factor graph is solved using factor graph optimization (FGO) to jointly optimize positioning and control of the UAV, and control inputs for the UAV are generated based on the optimized positioning and control.

In a preferred embodiment, the positioning-related factors include absolute factors constraining a state of the UAV at a specific timestamp, and relative factors constraining changes of the state between different timestamps. Preferably, the absolute factors are derived from GNSS measurements, while the relative factors are derived from LiDAR scan-matching measurements and/or IMU data. Advantageously, the state of the UAV includes position, attitude, velocity, and angular velocity.

In a further preferred or an alternative embodiment, the control-related factors include dynamic factors derived from a UAV dynamic model, reference trajectory factors for predicting a state close to a pre-planned trajectory, control bound factors for limiting control inputs, and control rate factors for limiting the rate of change of control inputs to smooth transitions. Preferably, aerodynamic drag forces are incorporated into the dynamic factors by modifying the UAV dynamic model to include a drag coefficient matrix, with residuals of the dynamic factors adjusted to account for aerodynamic effects.

In a further preferred or an alternative embodiment, the method further comprises applying a sliding window to optimize over a historical sequence of states and a predicted sequence of future states. Advantageously, the unified probabilistic factor graph is solved using a batch optimization framework to compute maximum a posteriori (MAP) estimates for states and control inputs, leveraging covariance matrices associated with sensor measurements and dynamic model uncertainties. Preferably, the control inputs are generated by solving the factor graph using a library for Georgia Tech Smoothing and Mapping (GTSAM).

According to a second aspect of the present application, there is provided a system for controlling a UAV. The system includes one or more sensors (e.g., GNSS, IMU, LIDAR), one or more processors, and memory storing instructions to execute the method as described above. In a further preferred or an alternative embodiment, the system incorporates aerodynamic drag forces into dynamic factors and applies a sliding window optimization framework.

According to a sixth aspect of the present application, there is provided a non-transitory computer-readable medium storing instructions that, when executed by a processor, cause the processor to perform the method as described in any of the preceding embodiments.

Advantageously, the invention enables coupling of positioning and control modules, dynamically adapting to epistemic uncertainty (e.g., wind disturbances) and aleatoric uncertainty (e.g., sensor noise). By unifying these traditionally decoupled processes, the system ensures robust and stable UAV motion control in complex environments such as urban canyons, where GNSS degradation and nonlinear dynamics challenge conventional architectures.

The present application proposes a tightly coupled model to solve motion control problems, which combines positioning constraints and control constraints into a probability factor graph. The measurements are categorized into absolute factors, such as the GNSS factor, and relative factors, like the LiDAR scan-matching factor. Additionally, dynamics, trajectory following, and control input constraints are formulated as control-based factors. All these factors are consolidated into a unified factor graph, which is then solved using GTSAM.

In order to eliminate the impact of aerodynamic drag force, the present application proposes JPCM-drag to tackle the path following offset. The dynamic model of UAV considers aerodynamic drag, which replaces the classical dynamic model in JCPM problem.

The present application significantly improves trajectory tracking accuracy and success rate compared to nominal MPC methods under conditions characterized by significant uncertainty. Moreover, the JPCM exhibits robust resilience. Concisely, after encountering rapid motion or serious observation errors, the controller will not exhibit excessive feedback. Resilience is a critical feature, as it ensures the stability of the system even in adverse conditions. By connecting measurement nodes, dynamics nodes, and control nodes, factor graphs of JPCM capture the uncertainty inherent in each component.

According to the seventh aspect of the present application, there is provided a system for motion control of a UAV, comprising: a positioning module configured to generate positioning constraints based on sensor measurements; a control module configured to generate control constraints using MPC; and a joint optimization module integrating the positioning constraints and control constraints into a unified probabilistic factor graph using FGO, wherein the factor graph is solved to simultaneously optimize positioning and control variables, thereby improving trajectory tracking accuracy under epistemic and aleatoric uncertainties. Preferably, the absolute factors include constraints on position, attitude, velocity of the UAV, and wherein the relative factors include constraints on pose transformations between sequential timestamps. Preferably, the dynamic factors incorporate a UAV dynamic model comprising rotor thrust, torque, inertial properties, and aerodynamic drag forces, the dynamic model represented by equations (1a)-(6) in the specification. Preferably, the control bound factors enforce actuator input limits using hinge loss functions, and the control rate factors penalize abrupt changes in control inputs to ensure smooth transitions. In a further preferred or an alternative embodiment, the system further comprises a sliding window module configured to integrate historical sensor measurements and predicted states over a fixed time horizon, enabling joint estimation of past, current, and future states within the factor graph. Preferably, the joint optimization processor solves the factor graph using maximum a posteriori (MAP) inference, leveraging covariance matrices associated with sensor measurements and dynamic model uncertainties. Preferably, the joint optimization processor employs Lie algebra operations to linearize nonlinear constraints on manifold representations of UAV states during factor graph solving.

According to the eighth aspect of the present application, there is provided an unmanned aerial vehicle (UAV) equipped with the above defined system, wherein the UAV is configured to perform trajectory tracking in dynamic environments with high positioning uncertainties and environmental disturbances.

Therefore, the present application achieves several technical effects through its joined positioning and control system for multi-rotor unmanned aerial vehicles. First, the system enables real-time operation of integrated positioning and control processes, ensuring simultaneous execution of state estimation and actuation without latency-induced performance degradation. A key feature of the invention lies in its control design, which adapts to uncertainties in the vehicle's state-such as those arising from sensor inaccuracies or environmental variability-without requiring manual parameter adjustments tied to positioning accuracy. This adaptability directly contributes to a measurable reduction in position tracking error during flight operations. Furthermore, the system significantly reduces shaking in the orientation of the unmanned aerial vehicle, enhancing stability even under dynamically changing conditions.

Collectively, these technical effects demonstrate three distinct advancements. First, the system exhibits robust control performance despite substantial measurement uncertainty, maintaining operational reliability where conventional systems might fail. Second, it provides strong resilience against external disturbances, such as large wind gusts. Third, the invention provides smoother and more accurate flight behavior compared to existing solutions. These advancements address critical limitations in multi-rotor UAV control, particularly in scenarios requiring real-time responsiveness, adaptability to imperfect state data, and stability under adverse environmental conditions.

A person skilled in the art would understand that the described embodiments may be implemented through hardware, software or a combination of both. This program can be stored in a computer-readable storage medium, such as read-only memory, a magnetic disk, or an optical disk. The described embodiments are optional and not meant to limit this application. Any modifications, equivalent replacements, improvements, etc., made within the spirit and principle of this application are included within its scope of protection.

### BRIEF DESCRIPTION OF THE FIGURES

The accompanying figures, which are incorporated in and constitute a part of this specification, illustrate one or more embodiments of the invention and, together with the description, serve to explain the principles of the invention.

FIG. 1 shows traditional motion control framework's pipeline of an unmanned aerial vehicle (UAV) of the prior art.

FIG. 2A shows a system for motion control of a UAV according to an embodiment of the present application.

FIG. 2B is a flow chart showing the method for motion control of a UAV according to an embodiment of the present application.

FIG. 3 shows framework and pipeline of a joined positioning and control model (JPCM) according to an embodiment of the present application.

FIG. 4 illustrates unification of representation and linearization of the positioning and MPC problem according to an embodiment of the present application.

FIG. 5 illustrates a structure of the quadrotor according to an embodiment of the present application.

FIG. 6 illustrates a factor graph of the proposed tight JPCM according to an embodiment of the present application.

FIG. 7 illustrates a simulation framework according to an embodiment of the present application.

FIG. 8 shows a simulation framework according to an embodiment of the present application.

FIG. 9 shows a position following residuals comparison between JPCM and MPC of case 1 according to an embodiment of the present application.

FIG. 10 shows a comparison of control input between MPC and JPCM of case 1 according to an embodiment of the present application.

FIG. 11 shows a position and rotation following residuals after abrupt movement according to an embodiment of the present application.

FIG. 12 shows a path comparison of JPCM method and JPCM-Drag method with aerodynamic drag according to an embodiment of the present application.

FIG. 13 shows predicted trajectory by MPC and JPCM.

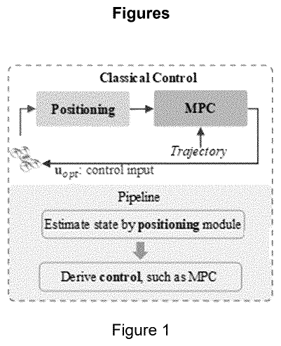

### DETAILED DESCRIPTION OF THE EMBODIMENTS

Detailed reference is now made to the embodiments of the present application, with the figures illustrating one or more embodiments. The repeated use of figure labels throughout this specification serves to indicate similar features or elements of the present application. The following content is provided to facilitate a further understanding of the present application for those skilled in the art but does not limit the application in any form. It should be noted that various modifications and changes can be made by those skilled in the art without departing from the concept of the present application. For example, features shown or described as part of one embodiment may be used in conjunction with another embodiment to generate further implementations. Consequently, the present application is intended to encompass such variations and changes within the scope of the appended claims and their equivalents.

The present invention provides a JPCM system and method for controlling an unmanned aerial vehicle (UAV) by unifying positioning and control within a single probabilistic framework. This integration addresses the limitations of traditional decoupled architectures, particularly in dynamic and uncertain environments such as urban canyons, where sensor reliability and environmental disturbances pose significant challenges.

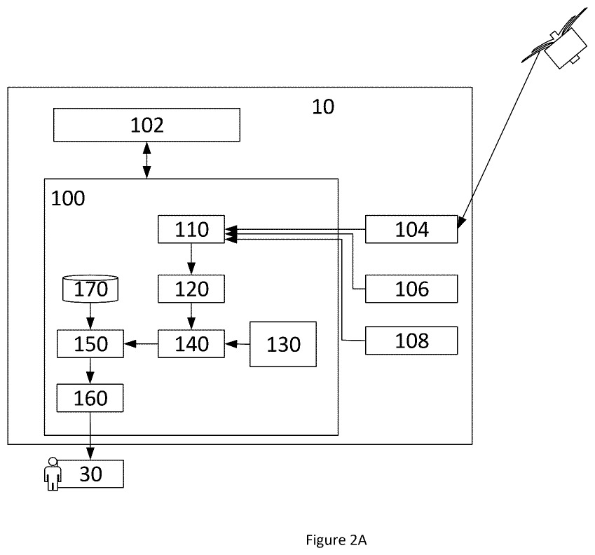

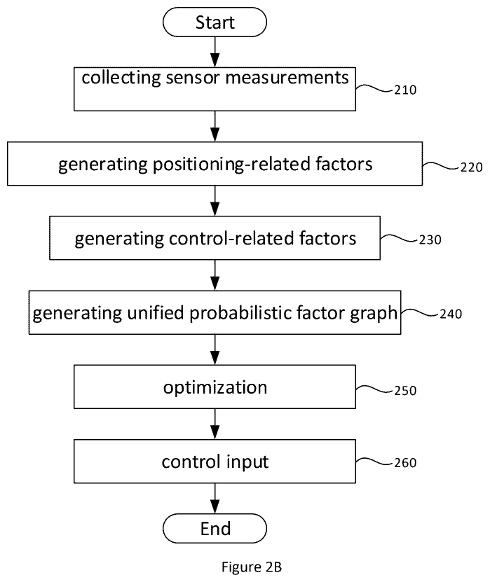

FIG. 2A illustrates a UAV 10 equipped with the motion control system according to an embodiment of the present application. The system interfaces with external resources (e.g., GNSS satellites 20) and delivers control outputs to UAV actuators 30 for users (e.g., autonomous flight controllers).

The UAV 10 comprises at least one memory 100 storing computer-readable program or instructions and at least one processor 102. The computer-readable program or instructions, upon execution by the processor 102, cause the JPCM system to implement the method as shown in FIG. 2B. The UAV 10 further includes a GNSS receiver 104, IMU 106, and LIDAR sensor 108. The GNSS receiver 104 is configured to receive absolute positioning data from GNSS satellites 20, though its accuracy degrades in urban environments due to multipath effects. The IMU 106 supply high-frequency relative motion data through accelerometers and gyroscopes, while the LiDAR sensor 108 is configured to generate precise 3D environmental maps.

As shown in FIGS. 2A and 2B, the memory 104 comprises interconnected program modules designed to collect, process, and optimize data for robust UAV control, including a sensor module 110, a positioning module 120, a control module 130, a factor graph constructor module 140, an optimization module 150, a control input generator module 160 and data storage module 170.

As shown in step 210 of FIG. 2B, the sensor module 110 is configured to collect raw sensor data from a GNSS receiver, IMU, and LiDAR sensors.

Subsequently, in step 220, the positioning-related factors and control-related factors are generated and fed into the factor graph constructor module 140 to generate a unified probabilistic factor graph.

In particular, the positioning module 120 is configured to generate positioning constraints based on sensor measurements and positioning-related factors (e.g., GNSS fixes, LiDAR scan-matching residuals) and positioning-related factors. The control module 130 is configured to generate control constraints using MPC and control-related factors (e.g., dynamic model constraints) and control-related factors.

Then, the positioning-related factors and control-related factors are provided to the factor graph constructor module 140 and then the factor graph constructor module 140 integrates positioning-related factors and control-related factors into a unified probabilistic factor graph.

In step 230, the optimization module 150 solves the factor graph using factor graph optimization (FGO) to compute maximum a posteriori (MAP) estimates for UAV states and control inputs.

In step 240, the control input generator module 160 translates optimized states into actuator commands (e.g., rotor speeds) so as to generate control input for users.

Preferably, the data storage module 170 is configured to stores historical states, sensor covariances, and control trajectories for real-time feedback.

The algorithm and implementation involved in the above JPCM system and method are detailed below.

In the proposed JPCM, the positioning cost function from sensor-based constraints and control cost function from MPC-based constraints are integrated into a tightly joined optimization problem. Both positioning and control of autonomous systems are fundamentally quadratic nonlinear optimization problems, although the control problem has additional equality and inequality constraints on variables to be optimized. Then, the joined cost function is converted into a unified factor graph. Finally, the tightly joined FGO problem is solved using the popular GTSAM library. By the MAP inference, the optimal control inputs can be extracted.

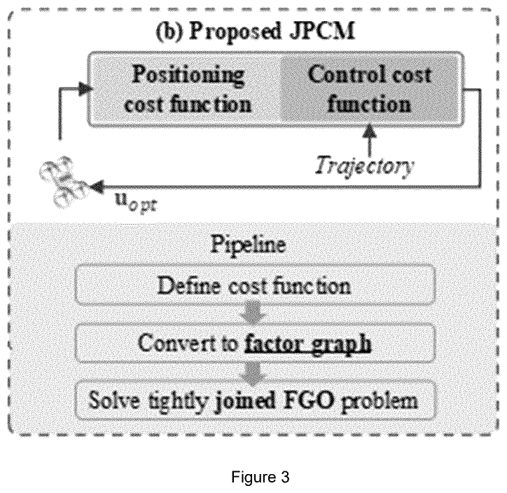

FIG. 3 shows framework and pipeline of an exemplary JPCM. The proposed JPCM integrates positioning and control into a cost function. Then, the cost function is converted to a probability factor graph, in which the positioning-related factors and MPC-based factors are tightly combined.

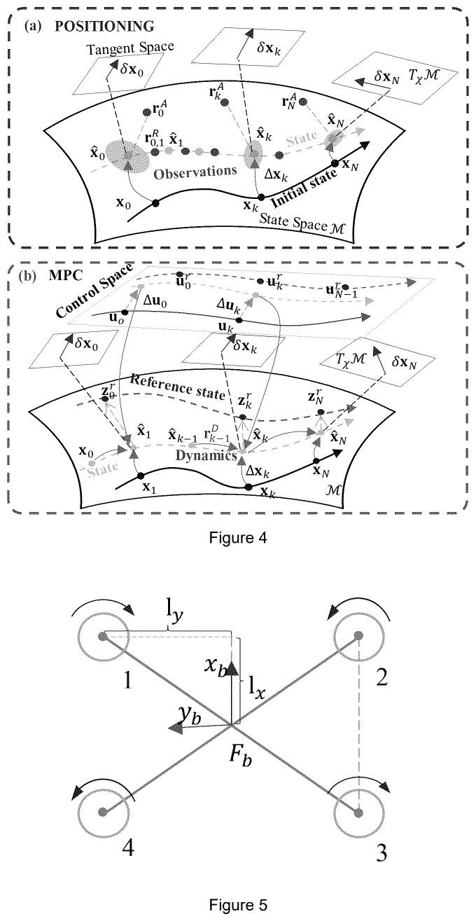

As shown in FIG. 3, both positioning (red box) and MPC (blue box) can be conceptualized as an optimization problem on-manifold. In the context of a canonical positioning model, factors derived from measurements can be categorized into two distinct types: absolute factors and relative factors. Absolute factors apply constraints to the robot's state at a specific moment, while relative factors constrain the variation between states at varying time intervals. For example, the measurement of IMU and LiDAR can construct relative factors. As for the MPC in the blue box FIG. 4, starting from an initial state x₀, contains constraints r^{ref} from the reference states z^{r}, constraints r^{D} from the dynamic model, and control input constraints. Mathematically, both positioning and control can be represented through probability factor graphs.

FIG. 4 shows the representation and linearization of the positioning and MPC problem can be unified. xₖ, \hat{x}ₖ, and z^{r} is the initial state, estimated state, and reference state, respectively. In positioning problem, \hat{x}ₖ is constrained by sensors' measurements. δx is the state increment in the tangent space during the optimization process. In MPC problem, \hat{x}ₖ is constrained by initial state x₀, dynamics and reference state z^{r}. In practical systems, the initial state x₀ in MPC comes from the positioning solution, but the uncertainty of the positioning solution is ignored. (a) Positioning is a probability FGO problem with absolute factors r^{A} and relative factors r^{R}, which will be discussed in Section III-B. (b) MPC can also be formulated as an FGO problem. The dynamic factors r^{D} become the informational bridge. The UAV dynamic model, positioning and MPC are further explored in the following sections.

### The UAV Dynamic Model

The generalization dynamics model of a UAV is as follows:

\dot{x}=f(x,t) (1a)

τ=g(u) (1b)

where

$$x = {[ {( {p}_{b}^{w} )}^{T} , {( {θ}_{b}^{w} )}^{T} , {( {v}_{b}^{w} )}^{T} , {( {ω}_{b}^{w} )}^{T} ]}^{T}$$

is the UAV's state that includes position

$${p}_{b}^{w} ,$$

rotation

$${R}_{b}^{w} = exp \{ {( {θ}_{b}^{w} )}^{\times } \} ,$$

velocity

$${v}_{b}^{w} ,$$

and angular speed ω_{b}, and

$$τ = {[ {T}_{b}^{T} , {M}_{b}^{T} ]}^{T}$$

represents the resultant thrust T_{b}∈ [symbol] and resultant torque M_{b}∈ [symbol] , and u=[u₀, . . . , uⱼ, . . . , u_{K}]^{T}, K≥3, K∈N is the control input vector, where uⱼ represents the angular speed of the j-th motor of the UAV. f(*) and g(*) represent the generalization dynamics model and control allocation model, respectively.

The continuous-time linearized dynamics of (1a) is as follows:

$${\dot{p}}_{b}^{w} = {v}_{b}^{w} \qquad ( 2 )$$

$${\dot{R}}_{b}^{w} = {R}_{b}^{w} {ω}_{b}^{\times }$$

$${\dot{v}}_{b}^{w} = - {R}_{G}^{w} {e}_{3} g + ( {R}_{b}^{w} {T}_{b} + {R}_{b}^{w} D {R}_{w}^{b} {v}_{b}^{w} ) / {m}_{b}$$

$${\dot{ω}}_{b} = {I}_{b}^{- 1} ( - {ω}_{b}^{\times } {I}_{b} {ω}_{b} + {M}_{b} )$$

where m_{b} is UAV's mass, e₃=[0,0,1]^{T}, g is the gravity constant, D is the aerodynamic drag coefficient matrix, and

$${ω}_{b}^{\times }$$

represents an operator that spins a 3D vector wp to a skew-symmetric as follows:

$${ω}_{b}^{\times } = [ \begin{matrix}0 & - {ω}_{3} & {ω}_{2} \\ {ω}_{3} & 0 & - {ω}_{1} \\ - {ω}_{2} & {ω}_{1} & 0\end{matrix} ] \qquad ( 3 )$$

I_{b} is the moment of inertia, which is usually regarded as a diagonal matrix:

$${I}_{b} = diag ( \begin{matrix}{I}_{b}^{1} & {I}_{b}^{2} & {I}_{b}^{3}\end{matrix} ) \qquad ( 4 )$$

Every rotor can generate aerodynamic thrust

$$F = {c}_{t} {u}_{j}^{2}$$

and aerodynamic torque

$${k}_{m} {u}_{j}^{2} .$$

The model of resultant thrust T_{b} and torque M_{b} are as follows:

$${T}_{b} = {\sum }_{j = 1}^{K} {e}_{3} {F}_{j}^{b} = {\sum }_{j = 1}^{K} {c}_{t} {u}_{j}^{2} {e}_{3} \qquad ( 5 )$$

$${M}_{b} = {\sum }_{j = 1}^{K} ( {p}_{{r}_{j}}^{b} \times {e}_{3} {F}_{j}^{b} + {( - 1 )}^{j - 1} {k}_{m} {e}_{3} {u}_{j}^{2} )$$

where uⱼ is the j-th (1≤j≤K) rotor's angular speed, cₜ is the rotor aerodynamic thrust coefficient, and kₘ is the rotor aerodynamic torque coefficient.

$${p}_{{r}_{j}}^{b}$$

is the j-th rotor's position in the body frame.

As shown in FIG. 5, according to (5), the typical quadrotor's thrust and torque model is as follows:

$$g ( u ) = [ \begin{matrix}0 & 0 & 0 & 0 \\ 0 & 0 & 0 & 0 \\ {c}_{t} & {c}_{t} & {c}_{t} & {c}_{t} \\ - {c}_{t} {l}_{y} & {c}_{t} {l}_{y} & {c}_{t} {l}_{y} & - {c}_{t} {l}_{y} \\ - {c}_{t} {l}_{x} & - {c}_{t} {l}_{x} & {c}_{t} {l}_{x} & {c}_{t} {l}_{x} \\ {k}_{m} & - {k}_{m} & {k}_{m} & - {k}_{m}\end{matrix} ] [ \begin{matrix}{u}_{1}^{2} \\ {u}_{2}^{2} \\ {u}_{3}^{2} \\ {u}_{4}^{2}\end{matrix} ] \qquad ( 6 )$$

where Iₓ and I_{y} are the length and width of every arm of the quadrotor.

To determine the covariance matrix of dynamic factor, an explicit noise model with additive Gaussian white noise is assumed as follows:

$${F}_{j} = {c}_{t} {u}_{j}^{2} + {n}_{A} , {n}_{A} ∼ 𝒩 ( 0 , s ) \qquad ( 7 )$$

where s is the variance. Based on the noise model assumption, the thrust covariance matrix

$${P}_{T}^{i}$$

and torque covariance matrix

$${P}_{M}^{i}$$

of the quadrotor can be derived as follows:

$${P}_{T}^{i} = 4 [ \begin{matrix}0 & 0 & 0 \\ 0 & 0 & 0 \\ 0 & 0 & s\end{matrix} ] \qquad ( 8 a )$$

$${P}_{M}^{i} = 4 [ \begin{matrix}{l}_{y}^{2} s & 0 & 0 \\ 0 & {l}_{x}^{2} s & 0 \\ 0 & 0 & {k}_{m}^{2} s\end{matrix} ] \qquad ( 8 b )$$

### Positioning Based on FGO

For simplicity, the observations of the absolute factor are assumed to include position, attitude, velocity, and angular velocity in the simulation. Multivariate Gaussian measurement assumption for state observation is used:

$${Φ}_{x} ∝ exp \{ \frac{1}{2} {‖ z ( {x}_{c} ) - {z}_{c} ‖}_{{P}_{c}}^{2} \} \qquad ( 9 )$$

where z_{c} is the actual observation, and z(x_{c}) is the predicted observation model.

In addition, the relative pose transformation

$${T}_{l + 1}^{l}$$

from the timestamp l to the timestamp l+1 is denoted as follows:

$${T}_{l + 1}^{l} = {( {T}_{{b}_{l}}^{w} )}^{- 1} {T}_{{b}_{l + 1}}^{w} \qquad ( 10 )$$

where

$${T}_{{b}_{l}}^{w}$$

represents UAV's pose at the timestamp l,

$${T}_{{b}_{l + 1}}^{w}$$

represent the UAV's pose at the timestamp l+1.

Hence, the relative factor is simplified as:

$${Φ}_{L} ∝ exp \{ \frac{1}{2} {‖ Logmap \{ {{T}_{l + 1}^{l} ( {T}_{{b}_{l + 1}}^{w} )}^{T} {T}_{{b}_{l}}^{w} \} ‖}_{{P}_{l}^{L}}^{2} \} \qquad ( 11 )$$

where

$${P}_{l}^{L}$$

is the covariance matrix of a relative pose from timestamp l to timestamp l+1. Based on (9) and (11), the residuals of absolute factor

$${r}_{c}^{A}$$

and relative factor

$${r}_{l}^{R}$$

are denoted as follows, respectively:

$${r}_{c}^{A} = z ( {x}_{c} ) - {z}_{c} \qquad ( 12 )$$

$${r}_{l}^{R} = Logmap \{ {{T}_{l + 1}^{l} ( {T}_{{b}_{l + 1}}^{w} )}^{T} {T}_{{b}_{l}}^{w} \}$$

### MPC Based on FGO

The general MPC problem is minimize a quadratic penalty on the error between the predicted states and inputs and a given dynamically feasible reference

$${z}_{k}^{r} and {u}_{k}^{r}$$

for the future time horizon N. Consequently, the cost function is as follows:

$${min}_{{u}_{0 : N - 1}} {\sum }_{k = 0}^{N - 1} ( {x}_{k}^{T} {W}_{k} {z}_{k}^{r} + {u}_{k}^{T} {Y}_{k} {u}_{k}^{r} ) + {x}_{N}^{T} {W}_{N} {z}_{N}^{r} , \qquad ( 13 )$$

$$s . t . {x}_{k + 1} = F ( {x}_{k} , {u}_{k} ) , 0 \leq k \leq N - 1 ,$$

$${x}_{0} = {x}_{init} ,$$

$${u}_{min} \leq {u}_{k} \leq {u}_{max} ,$$

where Wₖ≥0, R>0 and W_{N}≥0 are the state, input, and final state weighting matrices, respectively. N is the uₖ and

$${u}_{k}^{r} ( 0 \leq k \leq N - 1 )$$

are the input vector and the input set-point vector, respectively.

$${z}_{k}^{r} ( 1 \leq k \leq N - 1 ) and {z}_{N}^{r}$$

are reference states.

The control input's change rate uₜ−uₜ₊₁ is restricted due to itself driving capability. Furthermore, the input adheres to the bound limit function h(u). Further details will be discussed in Section IV. Consequently, (13) can be reformulated for representation in a factor graph as follows:

$${min}_{{u}_{0 : N - 1}} \{ \begin{matrix}{\sum }_{k = 1}^{N - 1} {‖ {x}_{k} - {z}_{k}^{r} ‖}_{{Q}_{k}}^{2} + {‖ {x}_{N} - {x}_{N}^{r} ‖}_{{Q}_{N}}^{2} + \\ {\sum }_{t = 0}^{N - 2} {‖ {u}_{t} - {u}_{t + 1} ‖}_{{R}_{t}}^{2} + {\sum }_{j = 0}^{N - 1} {‖ h ( {u}_{j} ) ‖}_{{Q}_{lim}}^{2}\end{matrix} \} , \qquad ( 14 )$$

$$s . t . {x}_{k + 1} = F ( {x}_{k} , {u}_{k} ) , 0 \leq k \leq N - 1 , {x}_{0} = {x}_{init}$$

where Qₖ, Q_{N}, Rₜ, and Qₗᵢₘ represent different weighting matrices.

In an illustrative embodiment of the present application, positioning and control are combined into a quadratic problem. Assuming M is the number of states to be estimated and N is the length of the predicted states. The unknown variables are

$$χ = {\{ {x}_{- M + 1 : N}^{T} , {u}_{0 : N - 1}^{T} \}}^{T} .$$

The unified optimization problem combines absolute factors, relative factors, and control-related factors. Therefore, JPCM's optimization problem is as follows:

$${min}_{χ} \{ \begin{matrix}{\sum }_{c = - M + 1}^{0} {‖ {r}_{c}^{A} ‖}_{{P}_{c}^{A}}^{2} + {\sum }_{l = - M + 1}^{- 1} {‖ {r}_{l}^{R} ‖}_{{P}_{l}^{L}}^{2} + {\sum }_{i = 0}^{N - 1} {‖ {r}_{i}^{D} ‖}_{{P}_{i}^{D}}^{2} + \\ {\sum }_{k = 1}^{N} {‖ {r}_{k}^{ref} ‖}_{{Q}_{k}}^{2} + {\sum }_{t = 0}^{N - 2} {‖ {r}_{t}^{U} ‖}_{{R}_{t}}^{2} + {\sum }_{j = 0}^{N - 1} {‖ h ( {u}_{j} ) ‖}_{{Q}_{lim}}^{2}\end{matrix} \} \qquad ( 15 )$$

Additionally, the control part involves the reference trajectory factor residuals r^{ref}=x−x^{ref}, dynamic factor residuals

$${r}_{i}^{D} = {x}_{i + 1} - F ( {x}_{i} , {u}_{i} ) ,$$

control bound factor residuals h(uⱼ), and control rate factor residuals

$${r}_{t}^{U} = {u}_{t} - {u}_{t + 1} .$$

These factors are further explained in the following sections.

To simplify the cost function of (15), below equation is obtained:

$${min}_{χ} \{ {f}_{sp} + {‖ {H}_{0} {x}_{0} - {z}_{0} ‖}_{{P}_{0}}^{2} + {f}_{dyn} + {f}_{MPC} \} \qquad ( 16 )$$

where

$${f}_{dyn} = {\sum }_{i = 0}^{N - 1} {‖ {r}_{i}^{D} ‖}_{{P}_{i}^{D}}^{2}$$

is the dynamic-related cost term, H₀ is the Jacobian matrix at \hat{x}₀, and z₀ is the observation of the initial state, and f_{MPC} is the cost function of MPC. Absolute factors and relative factors are reformulated to express the residuals H(x₀)−z₀ for the initial state x₀ and the cost function term fₛₚ for the subsequent states. If only the current state x₀ is considered, fₛₚ equals zero.

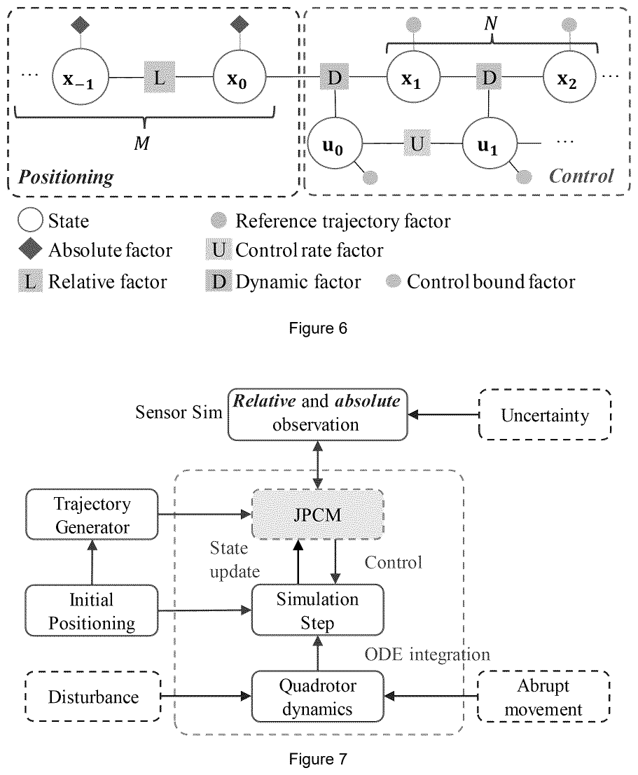

FIG. 6 is the factor graph of the proposed tight JPCM. The absolute factor and relative factor are two types of factors generated from common sensors, respectively. The dynamic factor is derived from the UAV's dynamic model, which bridges the gap between positioning and the control module. The reference trajectory factor makes predicted states close to the pre-planned trajectory.

Therefore, a unified factor graph framework is provided to implement the proposed JPCM. As illustrated in FIG. 6, this unified factor graph slides over a time window, which contains M states and N predicted states. The positioning component, highlighted in red, incorporates both absolute and relative factors. In the simulation, N=20, and M depends on the size of the sliding window. Additionally, the control component comprises the dynamic factor, reference trajectory factor, control rate factor, and control bound factor.

### Dynamic Factor

The dynamic factor serves as a crucial link, bridging the gap between positioning and control. The discrete form of state propagation is xᵢ₊₁=xᵢ+\dot{x}ᵢΔt. Thus, ignoring aerodynamic drag, the dynamic error can be represented through

$${r}_{i}^{D} = {[ {e}_{p}^{T} , {e}_{θ}^{T} , {e}_{v}^{T} , {e}_{ω}^{T} ]}^{T} = {x}_{i + 1} - {x}_{i} - {\dot{x}}_{i} Δ t$$

as follows:

$${e}_{p} = {p}_{{b}_{i + 1}}^{w} - {v}_{{b}_{i}}^{w} * Δ t - {p}_{{b}_{i}}^{w} \qquad ( 17 )$$

$${e}_{θ} = Log ( {R}_{w}^{{b}_{i + 1}} {R}_{{b}_{i}}^{w} ( {I}_{3 \times 3} + {ω}_{b}^{\times } Δ t )$$

$${e}_{v} = {v}_{{b}_{i + 1}}^{w} - {v}_{{b}_{i}}^{w} - ( - {R}_{G}^{w} {e}_{3} g + {R}_{{b}_{i}}^{w} {T}_{{b}_{i}} / {m}_{b} ) \cdot Δ t$$

$${e}_{ω} = {ω}_{{b}_{i + 1}} - {ω}_{{b}_{i}} - {I}_{b}^{- 1} ( {M}_{{b}_{i}} - {ω}_{{b}_{i}} \times {I}_{b} {ω}_{{b}_{i}} ) \cdot Δ t$$

where Δt is the period between two contiguous states. Log(*) and Exp(*) represent and Logarithmic map and Exponential map of Lie theory, respectively.

To propagate covariance, the dynamic model factor's error function

$${r}_{i}^{D} = {[ {\overline{e}}_{p}^{T} , {\overline{e}}_{θ}^{T} , {\overline{e}}_{v}^{T} , {\overline{e}}_{ω}^{T} ]}^{T}$$

can be derived from the error model (18):

$${\overline{e}}_{p} = {R}_{w}^{{b}_{i}} {m}_{b} ( {p}_{{b}_{i + 1}}^{w} - {v}_{{b}_{i}}^{w} Δ t + 0.5 {R}_{G}^{w} {e}_{3} g Δ {t}^{2} - {p}_{{b}_{i}}^{w} ) - 0.5 {T}_{{b}_{i}} Δ {t}^{2} \qquad ( 18 a )$$

$${\overline{e}}_{θ} = Log ( {R}_{w}^{{b}_{i}} {R}_{{b}_{i + 1}}^{w} ) - {ω}_{{b}_{i}} Δ t$$

$${\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t$$

$${\overline{e}}_{ω} = {I}_{b} ( {ω}_{{b}_{i + 1}} - {ω}_{{b}_{i}} ) - ( {M}_{{b}_{i}} - {ω}_{{b}_{i}} \times {I}_{b} {ω}_{{b}_{i}} ) \cdot Δt$$

If aerodynamic drag is further considered, according to (2), the velocity component ēᵥ of the dynamic factor's residual is as follows:

$${\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t - D {R}_{w}^{{b}_{i}} {v}_{{b}_{i}}^{w} Δ t \qquad ( 18 b )$$

According to (8) and (18a), the covariance matrix of ēᵥ and ē_{ω} are

$${P}_{T}^{i} Δ {t}^{2} and {P}_{M}^{i} Δ {t}^{2} ,$$

respectively. Moreover, the covariance matrix of ēₚ is set by

$$0.25 {P}_{T}^{i} Δ {t}^{4} .$$

The Jacobian matrix is provided in the Appendix.

### Control Bound Factor and Control Rate Factor

The control bound factor is designed to ensure that the control input meets the actuator's limits. Defining the hinge loss cost function E=h(uⱼ) for the control input inequality, which is as follows:

$${E}_{i} = \{ \begin{matrix}{u}_{min}^{j} + {u}_{thr}^{j} - {u}_{j} ( i ) & if {u}_{j} ( i ) < {u}_{min}^{j} + {u}_{thr}^{j} \\ {u}_{j} ( i ) - {u}_{max}^{j} + {u}_{thr}^{j} & if {u}_{max}^{j} - {u}_{thr}^{j} \leq {u}_{j} ( i ) \\ 0 & otherwise\end{matrix} \qquad ( 19 )$$

$$( 1 \leq i \leq K )$$

where

$${u}_{min}^{j}$$

is the input lower bound, and

$${u}_{max}^{j}$$

is the input upper bound, and

$${u}_{thr}^{j}$$

is the threshold value. In addition, Qₗᵢₘ is a control bound factor's weighting matrix which determines how fast the error grows as the value approaches the limit.

To smooth the trajectory, the control rate factor is used to limit the rate of control inputs, which is as follows:

$${r}_{t}^{U} = {u}_{t} - {u}_{t + 1} \qquad ( 20 )$$

### Reference Trajectory Factor

The reference trajectory factor's residual is as follows:

r^{ref}=(p,R,v)θ(p^{r},R^{r},v^{r}) (21)

where θ is a subtraction operator, which calculates the residuals of position, velocity, and rotation. The position residual is

$${e}_{p}^{ref} = p - {p}^{r} ,$$

the velocity residual is

$${e}_{v}^{ref} = v - {v}^{r} ,$$

and the rotation residual is

$${e}_{θ}^{r e f} = Log ( {R}^{T} {R}^{r} ) .$$

Then

$${r}^{r e f} = {[ \begin{matrix}{( {e}_{p}^{r e f} )}^{T} & {( {e}_{v}^{r e f} )}^{T} & {( {e}_{θ}^{r e f} )}^{T}\end{matrix} ]}^{T} .$$

In addition, the reference trajectory factor's covariance Qₖ(1≤k≤N) can be configured by users.

The quadrotor's trajectory control simulation is conducted to evaluate the proposed JPCM's performance. The reference path is assumed to be a circle. Then, the trajectory is generated by the minimum snap trajectory generation method. Moreover, the Gaussian white noise is added to the thrust and torque of the quadrotor simulator. In particular, the reasons that the simulated dataset is employed to validate the effectiveness of the proposed method lie in three folds: (1) By employing the simulation, the noise of the positioning module can be ideally simulated using the Gaussian noise which is hard to achieve in real environments. (2) The external disturbance can be accurately modeled using simulated environments which is important for the validation of the proposed method. (3) By using simulated environments, the dynamic parameters of the UAV system can also be accurately modeled. More importantly, the full implementation of the model in this paper is open-source to benefit the research community.

The gravity of the quadrotor is 10 N (Newton). The thrust noise's sigma is 0.1N, and the angular speed process noise's sigma is 0.02 rad/s. The simulated circle trajectory's linear speed is 5 m/s, and its radius is 1.5 m. The control frequency is 100 Hz. It is assumed that the absolute factor's measurement not only includes position, velocity, and angular speed but also the attitude with simulated uncertainty. As shown in FIG. 7, simulation of a quadrotor is based on the quadratic thrust model (5). In the dynamic model of the present application, various disturbances including the aerodynamic drag force, Gaussian noise, abrupt motion are incorporated. This enables validating the trajectory tracking performance of the algorithm of the preferred embodiment under challenging conditions characterized by high uncertainty.

A. Performance Comparison Between MPC and JPCM with High Positioning Uncertainty
Illustration of the Abbreviations of Different Methods to be Evaluated in this Paper:
MPC-pre represents the MPC method with highly precise positioning.
MPC represents the MPC method with highly uncertain observation with parameters listed in Table 1
JCPM represents the proposed tightly joined positioning and control model with highly uncertain observation for below Case 1.
JCPM-SW represents the proposed tightly joined positioning and control model based on a sliding window with highly uncertain observation for below Case 2.
   Case 1: First, it is assumed that only absolute measurements exist at the current moment. Similarly, a state with uncertainty output by the common positioning module is provided to the MPC and JPCM. Both MPC and JPCM are implemented based on FGO. MPC directly adopts the observation of the current state as the initial state.
   Case 2: In addition to the conditions of case 1, it is assumed that the UAV is equipped with a LiDAR and can measure the pose transformation at adjacent timestamps. The length of the variables to be estimated is set to 10. The extrinsic parameter between the LiDAR frame and the body frame is an identity matrix. Verify the feasibility of the proposed method under these conditions. JPCM is defined based on sliding window as JPCM-Sliding Window (JPCM-SW). The relative pose transformation

$${T}_{l + 1}^{l}$$

with the Gaussian white noise nₗ is simulated as follows:

$${T}_{l + 1}^{l} = {\hat{T}}_{l + 1}^{l} E x p m a p ( {n}_{l} ) \qquad ( 22 )$$

where

$${\hat{T}}_{l + 1}^{l}$$

is the true value of relative pose.

All simulation parameters are listed in Table 1.

TABLE 1
SIMULATION PARAMETERS

| Parameters | Case 1 | | Case 2 |
|---|---|---|---|
| M (the length of historical states in positioning) | 1 | | 10 |
| N (the length of predicted states in control) | 20 | | |
| Position sigma | 0.20 | m | |
| Rotation sigma | 0.03 | rad | |
| Velocity sigma | 0.05 | m/s | |
| Angular velocity sigma | 0.001 | rad/s | |

| $Sigma of {T}_{l + 1}^{l}$ | $diag \{ {0.03}^{2} {I}_{3}^{T} , {0.03}^{2} {I}_{3}^{T} \}$ |
|---|---|
| ${P}_{l}^{L}$ | $diag \{ {0.03}^{2} {I}_{3}^{T} , {0.03}^{2} {I}_{3}^{T} \}$ |
| Qₖ | $diag \{ {0.03}^{2} {I}_{3}^{T} , {0.03}^{2} {I}_{3}^{T} , {3}^{2} {I}_{3}^{T} \}$ |
| Q_{N} | $diag \{ {0.01}^{2} {I}_{3}^{T} , {0.03}^{2} {I}_{3}^{T} , {3}^{2} {I}_{3}^{T} \}$ |
| Rₜ | $diag \{ 1000 {I}_{4}^{T} \}$ |
| uₘᵢₙ | 12000 |
| uₜₕᵣ | 100 |
| uₘₐₓ | 18000 |

### 1) Simulation Results of Case 1

For case 1, FIG. 7 illustrates the path of MPC and JPCM, which shows that JPCM aligns more closely with the reference path than the MPC method. In contrast, the nominal MPC exhibits significant fluctuation.

### 2) Simulation Results of Case 1

For case 1, FIG. 7 illustrates the path of MPC and JPCM, which shows that JPCM aligns more closely with the reference path than the MPC method. In contrast, the nominal MPC exhibits significant fluctuation.

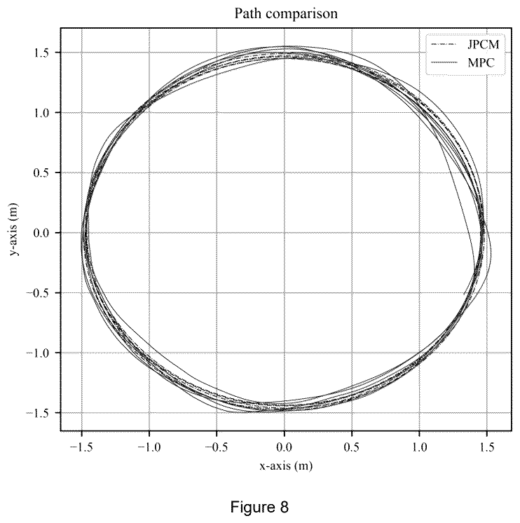

FIG. 8 shows the paths of MPC and JPCM (linear speed=5 m/s, radius=1.5 m) in case 1. The solid line and dash-dotted line represent the tracking path based on MPC and the tracking path based on JPCM, respectively.

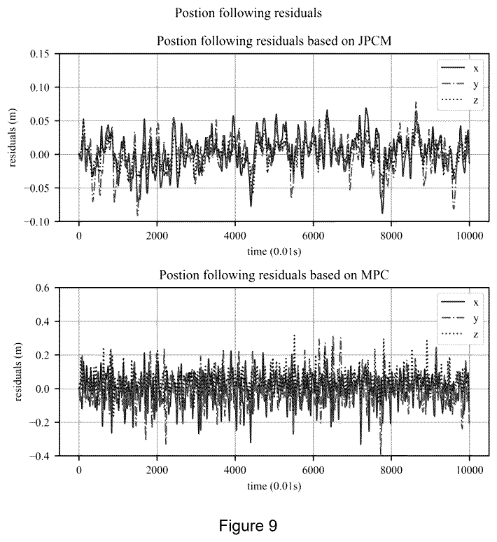

The root mean square errors (RMSEs) are also summarized in Table 2. Furthermore, the rotation and position control errors are depicted in FIG. 9. MPC-pre represents the MPC method with high-precision positioning. When positioning measurements are precise, the MPC problem solved by FGO converges to the reference trajectory with minimal control errors. Table 2 reveals that both the position and rotation control errors of the proposed JPCM are reduced compared to the nominal MPC with large noise positioning. This indicates that noisy positioning adversely affects the control performance of UAVs.

TABLE 2
THE TRAJECTORY FOLLOWING RMSE OF MPC-PRE (MPC WITH
PRECISE POSITIONING), MPC, JPCM, AND JPCM-SW

| Method | Position RMSE (m) | | | Rotation RMSE (rad) | | |
|---|---|---|---|---|---|---|
| MPC-pre | 0.010 | 0.010 | 0.005 | 0.005 | 0.005 | 0.004 |
| MPC | 0.068 | 0.066 | 0.055 | 0.246 | 0.151 | 0.251 |
| JPCM | 0.031 | 0.019 | 0.015 | 0.031 | 0.018 | 0.158 |
| JPCM-SW | 0.017 | 0.017 | 0.019 | 0.010 | 0.011 | 0.205 |

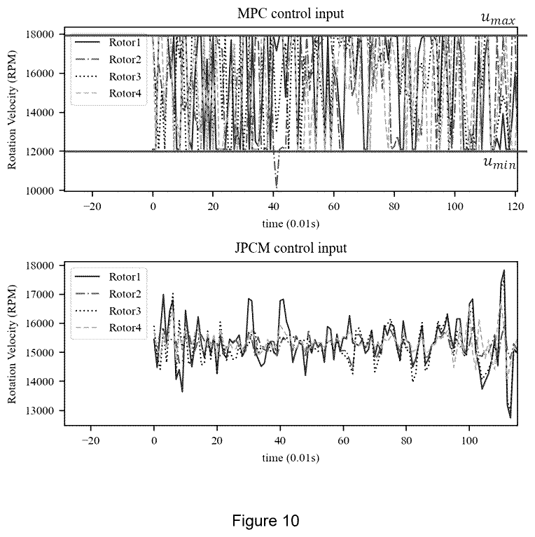

As shown in FIG. 10, under highly uncertain observations, the MPC's control inputs often reach the upper or lower bound. On the contrary, the control inputs of the JPCM are relatively concentrated. The MPC is probing at the edge of the control boundary, indicating that the solution of the control quantity is on the verge of reaching a critical constraint. Specifically, when the positioning value strays excessively from the intended target, the optimization process may fail to procure a viable solution.

### 3) Simulation Results of Case 2

As for case 2, the JPCM-SW is conducted with M=10. As demonstrated in Table 2, the JPCM-SW method exhibits a slight reduction in both the x-axis and γ-axis position following residuals when compared to the standard JPCM method. The enhanced performance of JPCM-SW is achieved through a tightly integrated approach that effectively combines historical observations with control objectives. By utilizing more historical information, the JPCM-SW method achieves higher precise control than MPC.

MPC can handle most control tasks effectively when the positioning accuracy is high. However, in urban scenarios where severe positioning noise is prevalent, the trajectory following the error of MPC may be significantly exacerbated. In contrast, the proposed JPCM substantially improves trajectory tracking performance in situations where positioning uncertainty is high. To conclude, the performance of JPCM based on FGO surpasses that of the standard MPC, particularly when precise positioning is not available.

### B. Performance Comparison Under Disturbances

### (1) Abrupt Movements

Sudden winds or brief malfunctions can cause UAVs to experience instantaneous movement. This poses a risk to the stability of the control. The process of recovering to a predetermined trajectory after a rapid and large movement is referred to as a “recovery process”. A rapid and large movement at one moment is simulated to investigate the “recovery process”.

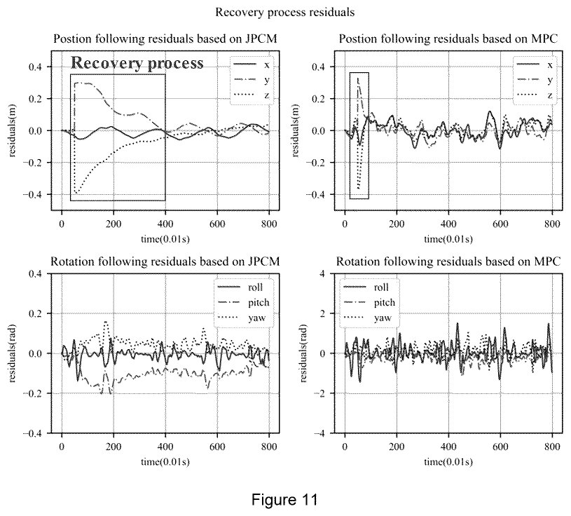

As illustrated in FIG. 11, an unplanned movement

$$Δ {p}_{b}^{w} = {[ 0.00 m , 0.3 m , - 0.4 m ]}^{T}$$

is simulated at 0.5 seconds, and the UAV controlled by JPCM returns to the planned trajectory in about three seconds. In comparison to MPC, the recovery process of the proposed JPCM method takes a longer duration. However, JCPM renders a smoother position tracking error curve according to FIG. 11. The disadvantage is that when JPCM experiences significant movement disturbances, the control delay will be greater. Conversely, in scenarios that pursue smoother control, this becomes an advantage. For example, in the case of positioning outliers or spoofing, smoother and slower JPCM is more robust than MPC. Besides, the control delay can be accepted in practical systems.

### (2) Aerodynamic Drag

First, the performance of JPCM affected by the aerodynamic drag (not considering aerodynamic drag factors in the controller) is investigated. Then, to mitigate the effects of aerodynamic drag force, a drag-aiding JPCM method, namely JPCM-Drag, is introduced.

To evaluate the performance of the proposed JPCM under the simulated parameters in Table 1 Case 1, four prevalent aerodynamic drag coefficients are strategically chosen. An analysis of the data presented in Table 3 indicates a direct correlation between the trajectory position tracking error of JPCM and the magnitude of the aerodynamic drag coefficient. Despite the increase in error, it is noteworthy that the system maintains its stability and does not diverge.

TABLE 3
THE TRAJECTORY FOLLOWING RMSE OF JPCM AND
JPCM-DRAG WITH AERODYNAMIC DRAG FORCE

| | Drag | | | | | | |
|---|---|---|---|---|---|---|---|
| Method | parameter | Position RMSE (m) | | | Rotation RMSE (rad) | | |
| JPCM | 0 | 0.026 | 0.025 | 0.018 | 0.022 | 0.016 | 0.024 |
| JPCM | 0.1I_{3×3} | 0.040 | 0.031 | 0.024 | 0.023 | 0.013 | 0.045 |
| JPCM | 0.2I_{3×3} | 0.053 | 0.047 | 0.035 | 0.018 | 0.023 | 0.040 |
| JPCM | 0.3I_{3×3} | 0.067 | 0.061 | 0.039 | 0.032 | 0.036 | 0.062 |
| JPCM-Drag | 0.3I_{3×3} | 0.031 | 0.025 | 0.028 | 0.011 | 0.037 | 0.064 |

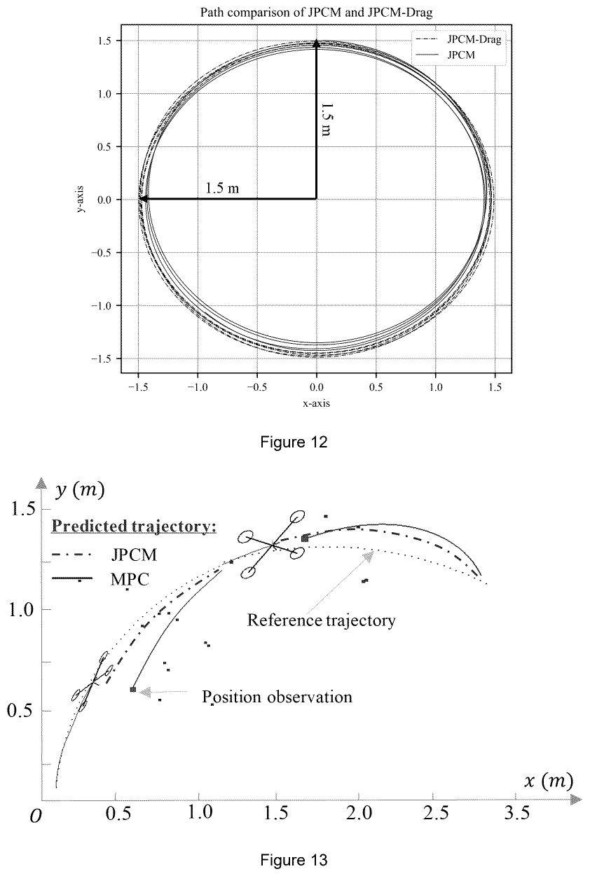

Eliminating aerodynamic drag effects: JPCM-Drag incorporates the aerodynamic drag into the error function (19b) and recalculates the Jacobian matrix of the modified dynamic model factor. This is achieved by integrating a non-zero coefficient matrix, denoted as D, into the formulas provided in the Appendix. A specific instance of this method is demonstrated where D is set to 0.3I_{3×3} that is consistent with the actual system level. As shown in FIG. 12, the JPCM method reveals a significant deviation in the circular trajectory towards the center of the circle. The shift is attributed to the influence of aerodynamic drag. The JPCM-Drag method, which accounts for this drag effect, shows a tendency to converge towards the pre-set trajectory. Furthermore, when the JPCM-Drag method is implemented, the RMSE of the position following closely approximates the RMSE in scenarios devoid of aerodynamic drag. This observation underscores the efficacy of the JPCM-Drag method in neutralizing the impact of aerodynamic drag.

When substantial errors occur in the initial state, they can induce significant fluctuations in the predicted trajectory, as evidenced by the MPC in FIG. 13 from simulation software. This discrepancy arises because the motion control solution fails to align with the actual position of the UAV, potentially leading to unstable control, and any attitude jitter can pose a significant safety risk. This is due to the potential for rapid, unpredictable changes in the UAV's orientation, which could lead to loss of control or collision. However, a control mechanism that incorporates the initial positioning probability may mitigate the risks due to positioning uncertainty. As shown in FIG. 13, the predicted trajectory of JPCM is more in line with the true state of UAV.

If the covariance matrix P₀ in (16) approaches 0, that is, when the positioning accuracy is high, JPCM equivalents the MPC problem. However, in real-world applications that permeate our daily lives, such as autonomous vehicles navigating city streets and cooperative robots performing tasks in indoor environments, the financial burden associated with achieving high-precision capabilities may be substantial. In some instances, the attainment of such precision may not even be feasible, thus posing significant challenges to the implementation of these advanced technologies. In contrast, JPCM is equivalent to relaxing the fixed-value constraints in the MPC problem into a probabilistic constraint on the initial variables. This relaxation allows for greater flexibility in the control mechanism, potentially improving the UAV's ability to handle unexpected changes in its environment or initial state.

Moreover, the recovery process demonstrates that the proposed JPCM necessitates a longer duration to revert to the pre-set path in comparison to the conventional MPC. This can be attributed to the simultaneous optimization of positioning and control. The constraints imposed by the planned trajectory exert a pull on the estimated state, drawing it closer to the trajectory, which, in turn, diminishes the control energy. The traditional MPC, with its ability to plan actions with decisiveness, is more prone to fluctuations with bad positioning. It is a stark contrast to the controller based on JPCM, which exhibits resilience to faults triggered by irregular positioning or sudden, large-scale movements.

To establish a tightly integrated model with positioning and control, the present application provides a tight JPCM. The model combines positioning and control into a unified factor graph. Additionally, we provide a design framework for the unified factor graph, formulating a series of factors pertinent to positioning, dynamic control and trajectory tracking. These factors are instrumental in ensuring precise and efficient control over the system's trajectory. Finally, a quadrotor simulator is used to evaluate the proposed method's performance. The simulation results show that the proposed method is convergent with smaller errors than the conventional MPC.

The systems, devices, modules, or units described in the above embodiments can be implemented by computer chips or physical entities, or by products with specific functionalities. A typical implementation device is a computer.

From the description of the above implementation methods, it can be understood that those skilled in the art can clearly see that this specification can be implemented by means of software combined with a necessary general-purpose hardware platform. Based on this understanding, the technical solutions of this specification, or the part that contributes to the prior art, can essentially be embodied in the form of a software product. This computer software product can be stored in a storage medium, such as ROM/RAM, magnetic disks, optical disks, etc., and includes several instructions to enable a computer device (which can be a personal computer, server, or network device, etc.) to execute the methods described in the various embodiments or certain parts of the embodiments of this specification.

The various embodiments in this specification are described in a progressive manner, where the same or similar parts between the embodiments can be referred to each other. Each embodiment focuses on explaining the differences from other embodiments. In particular, for the system embodiments, since they are largely similar to the method embodiments, the description is relatively brief, and the relevant parts can be referred to in the description of the method embodiments.

This specification can be described in the general context of computer-executable instructions executed by a computer, such as program modules. Generally, program modules include routines, programs, objects, components, data structures, etc., that perform particular tasks or implement particular abstract data types. This specification can also be practiced in distributed computing environments where tasks are performed by remote processing devices that are linked through a communication network. In a distributed computing environment, program modules may be located in both local and remote computer storage media, including storage devices.

Although this specification is illustrated through embodiments, those of ordinary skill in the art will understand that this specification can have many modifications and variations without departing from its spirit. It is intended that the appended claims cover such modifications and variations without departing from the spirit of this specification.

1. A method for controlling an unmanned aerial vehicle (UAV), comprising:
receiving sensor measurements from one or more sensors;
constructing a unified probabilistic factor graph by integrating positioning-related factors derived from the sensor measurements and control-related factors derived from a model predictive control (MPC);
solving the unified probabilistic factor graph using factor graph optimization (FGO) to jointly optimize positioning and control of the UAV; and
generating control inputs for the UAV based on the optimized positioning and control.

2. The method of claim 1, wherein the positioning-related factors include absolute factors constraining a state of the UAV at a specific timestamp, and relative factors constraining changes of the state of the UAV between different timestamps, and wherein the state of the UAV includes at least one of the following: position, rotation, attitude, pose, velocity and angular velocity of the UAV.

3. The method of claim 2, wherein the absolute factors are derived from global navigation satellite system (GNSS) measurements provided by a GNSS receive; and the relative factors are derived from light detection and ranging (LiDAR) scan-matching measurements provided by a LIDAR sensor and/or inertial measurement unit (IMU) measurements provided by an IMU.

4. The method of claim 2, wherein the control-related factors include at least one of the following:
dynamic factors converted from dynamics constraints and derived from a UAV dynamic model of UAV dynamics;
control bound factors converted from control bound constraints for limiting control inputs;
control rate factors converted from control rate constraints for limiting rate of change of control inputs and smoothing control input transitions; and
reference trajectory factors converted from trajectory tracking constraints for predicting a state close to a pre-planned trajectory.

5. The method of claim 4, further comprising incorporating aerodynamic drag forces into the dynamic factors by modifying the UAV dynamic model to include a drag coefficient matrix, and residuals of the dynamic factors are adjusted to account for aerodynamic effects.

6. The method of claim 5, wherein the positioning and the control are linked by the dynamic factors.

7. The method of claim 4, further comprising applying a sliding window to optimize over a historical sequence of states and a predicted sequence of future states.

8. The method of claim 7, wherein the unified probabilistic factor graph is solved using the FGO to compute maximum a posteriori (MAP) estimates for states and control inputs, using covariance matrices associated with the sensor measurements and dynamic model factors.

9. The method of claim 8, wherein the control inputs are generated by solving the factor graph using a library for Georgia Tech Smoothing and Mapping (GTSAM).

10. The method of claim 9, wherein a joint cost function of the unified probabilistic factor graph is represented by below formula:
$$\begin{matrix}min \\ χ\end{matrix} \{ \begin{matrix}{\sum }_{c = - M + 1}^{0} {‖ {r}_{c}^{A} ‖}_{{P}_{c}^{A}}^{2} + {\sum }_{l = - M + 1}^{- 1} {‖ {r}_{l}^{R} ‖}_{{P}_{l}^{L}}^{2} + {\sum }_{i = 0}^{N - 1} {‖ {r}_{i}^{D} ‖}_{{P}_{i}^{D}}^{2} + \\ {\sum }_{k = 1}^{N} {‖ {r}_{k}^{ref} ‖}_{{Q}_{k}}^{2} + {\sum }_{t = 0}^{N - 2} {‖ {r}_{t}^{U} ‖}_{{R}_{t}}^{2} + {\sum }_{j = 0}^{N - 1} {‖ h ( {u}_{j} ) ‖}_{{Q}_{lim}}^{2}\end{matrix} \}$$
where M is the number of states to be estimated and N is the length of the predicted states,
$${r}_{c}^{A}$$
is residual of absolute factor and
$${r}_{l}^{R}$$
is residual of relative factor,
$${r}_{i}^{D}$$
is residual of dynamic factor, r^{ref} is residual of reference trajectory factor, uⱼ represents the angular speed of the j-th motor of the UAV and h(uⱼ) is residual of control bound factor, and
$${r}_{t}^{U}$$
is residual of control rate factor, and where
$${P}_{i}^{D} , {P}_{c}^{A} , {P}_{l}^{L} {Q}_{k} , {R}_{t} ,$$
and Qₗᵢₘ represent weighting matrices or covariance matrices.

11. The method of claim 10, wherein the residual of dynamic factor
$${r}_{i}^{D}$$
is derived from below error model:
$$\begin{matrix}{\overline{e}}_{p} = {R}_{w}^{{b}_{i}} {m}_{b} ( {p}_{{b}_{i + 1}}^{w} - {v}_{{b}_{i}}^{w} Δ t + 0.5 {R}_{G}^{w} {e}_{3} g Δ {t}^{2} - {p}_{{b}_{i}}^{w} ) - 0.5 {T}_{{b}_{i}} Δ {t}^{2} \\ {\overline{e}}_{θ} = Log ( {R}_{w}^{{b}_{i}} {R}_{{b}_{i + 1}}^{w} ) - {ω}_{{b}_{i}} Δ t \\ {\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t - D {R}_{w}^{{b}_{i}} {v}_{{b}_{i}}^{w} Δ t \\ {\overline{e}}_{ω} = {I}_{b} ( {ω}_{{b}_{i + 1}} - {ω}_{{b}_{i}} ) - ( {M}_{{b}_{i}} - {ω}_{{b}_{i}} \times {I}_{b} {ω}_{{b}_{i}} ) \cdot Δ t\end{matrix}$$
Where
$${R}_{b}^{w}$$
is rotation of the UAV, m_{b} is mass of the UAV,
$${p}_{b}^{w}$$
is position of the UAV,
$${v}_{b}^{w}$$
to velocity of the UAV, and ω_{b} is angular speed of the UAV, Δt is the period between two contiguous states, Log(*) represent a Logarithmic map of Lie theory, e₃=[0,0,1]^{T}, g is the gravity constant, D is the aerodynamic drag coefficient matrix and
$${ω}_{b}^{\times }$$
represents an operator that spins a 3D vector ω_{b}, T_{b} is resultant thrust, M_{b} is resultant torque, I_{b} is the moment of inertia,
$${R}_{G}^{w}$$
is the gravity vector attitude in the world frame,
$${R}_{w}^{{b}_{i}}$$
is the transpose matrix of
$${R}_{{b}_{i}}^{w} .$$

12. The method of claim 10, wherein the residual of control bound factor h(uⱼ) is derived from a hinge loss cost function E=h(uⱼ) for the control input inequality, which is as follows:
$${E}_{i} = \{ \begin{matrix}{u}_{min}^{j} + {u}_{thr}^{j} - {u}_{j} ( i ) & if {u}_{j} ( i ) < {u}_{min}^{j} + {u}_{thr}^{j} \\ {u}_{j} ( i ) - {u}_{max}^{j} + {u}_{thr}^{j} & if {u}_{max}^{j} + {u}_{thr}^{j} \leq {u}_{j} ( i ) \\ 0 & otherwise\end{matrix}$$
$$( 1 \leq i \leq K )$$
where
$${u}_{min}^{j}$$
is an input lower bound, and
$${u}_{max}^{j}$$
is an input upper bound, and
$${u}_{thr}^{j}$$
is a threshold value, Qₗᵢₘ is a control bound factor's weighting matrix which determines how fast the error grows as the value approaches the limit, and uⱼ represents the angular speed of the j-th motor of the UAV.

13. A system for controlling an unmanned aerial vehicle (UAV) comprising:
one or more sensors;
one or more processors; and
one or more memories storing computer-readable instructions that, upon execution by the one or more processors, cause the system to:
receive sensor measurements from the one or more sensors,
construct a unified probabilistic factor graph by integrating positioning-related factors derived from the sensor measurements and control-related factors derived from a model predictive control (MPC);
solve the unified probabilistic factor graph using factor graph optimization (FGO) to jointly optimize positioning and control of the UAV; and
generate control inputs for the UAV based on the optimized positioning and control.

14. The system of claim 13, wherein the positioning-related factors include absolute factors constraining a state of the UAV at a specific timestamp, and relative factors constraining changes of the state of the UAV between different timestamps, and wherein the state of the UAV includes at least one of the following: position, rotation, attitude, pose, velocity and angular velocity of the UAV.

15. The system of claim 14, wherein the absolute factors are derived from global navigation satellite system (GNSS) measurements provided by a GNSS receive; and the relative factors are derived from light detection and ranging (LiDAR) scan-matching measurements provided by a LIDAR sensor and/or inertial measurement unit (IMU) measurements provided by an IMU.

16. The system of claim 14, wherein the control-related factors include at least one of the following:
dynamic factors converted from dynamics constraints and derived from a UAV dynamic model of UAV dynamics;
control bound factors converted from control bound constraints for limiting control inputs;
control rate factors converted from control rate constraints for limiting rate of change of control inputs and smoothing control input transitions; and
reference trajectory factors converted from trajectory tracking constraints for predicting a state close to a pre-planned trajectory.

17. The system of claim 16, further comprising incorporating aerodynamic drag forces into the dynamic factors by modifying the UAV dynamic model to include a drag coefficient matrix, and residuals of the dynamic factors are adjusted to account for aerodynamic effects.

18. The system of claim 17, wherein the positioning and the control are linked by the dynamic factors.

19. The system of claim 16, further comprising a sliding window applied to optimize over a historical sequence of states and a predicted sequence of future states.

20. The system of claim 19, wherein the unified probabilistic factor graph is solved using the FGO to compute maximum a posteriori (MAP) estimates for states and control inputs, using covariance matrices associated with the sensor measurements and dynamic model factors.

21. The system of claim 20, wherein the control inputs are generated by solving the factor graph using a library for Georgia Tech Smoothing and Mapping (GTSAM).

22. The system of claim 21, wherein a joint cost function of the unified probabilistic factor graph is represented by below formula:
$${min}_{ϰ} \{ \begin{matrix}{\sum }_{c = - M + 1}^{0} {‖ {r}_{c}^{A} ‖}_{{P}_{c}^{A}}^{2} + {\sum }_{l = - M + 1}^{- 1} {‖ {r}_{l}^{R} ‖}_{{P}_{l}^{L}}^{2} + {\sum }_{i = 0}^{N - 1} {‖ {r}_{i}^{D} ‖}_{{P}_{i}^{D}}^{2} \\ {+ \sum }_{k = 1}^{N} {‖ {r}_{k}^{ref} ‖}_{{Q}_{k}}^{2} + {\sum }_{t = 0}^{N - 2} {‖ {r}_{t}^{UA} ‖}_{{R}_{t}}^{2} + {\sum }_{j = 0}^{N - 1} {‖ h ( {u}_{j} ) ‖}_{{Q}_{lim}}^{2}\end{matrix} \}$$
where M is the number of states to be estimated and N is the length of the predicted states
$${r}_{c}^{A}$$
is residual of absolute factor and
$${r}_{l}^{R}$$
is residual of relative factor,
$${r}_{i}^{D}$$
is residual of dynamic factor, r^{ref} is residual of reference trajectory factor, uⱼ represents the angular speed of the j-th motor of the UAV and h(uⱼ) is residual of control bound factor, and
$${r}_{t}^{U}$$
is residual of control rate factor, and where
$${P}_{i}^{D} , {P}_{C}^{A} , {P}_{l}^{L} {Q}_{k} , {R}_{t} ,$$
and Qₗᵢₘ represent weighting matrices or covariance matrices.

23. The system of claim 22, wherein the residual of dynamic factor
$${r}_{i}^{D}$$
is derived from below error model:
$$\begin{matrix}{\overline{e}}_{p} = {R}_{w}^{{b}_{i}} {m}_{b} ( {p}_{{b}_{i + 1}}^{w} - {v}_{{b}_{i}}^{w} Δ t + 0.5 {R}_{G}^{w} {e}_{3} g Δ {t}^{2} - {p}_{{b}_{i}}^{w} ) - 0.5 {T}_{{b}_{i}} Δ {t}^{2} \\ {\overline{e}}_{θ} = Log ( {R}_{w}^{{b}_{i}} {R}_{{b}_{i + 1}}^{w} ) - {ω}_{{b}_{i}} Δ t \\ {\overline{e}}_{v} = {R}_{w}^{{b}_{i}} {m}_{b} ( {v}_{{b}_{i + 1}}^{w} - {v}_{{b}_{i}}^{w} + {R}_{G}^{w} {e}_{3} g Δ t ) - {T}_{{b}_{i}} Δ t - D {R}_{w}^{{b}_{i}} {v}_{{b}_{i}}^{w} Δ t \\ {\overline{e}}_{ω} = {I}_{b} ( {ω}_{{b}_{i + 1}} - {ω}_{{b}_{i}} ) - ( {M}_{{b}_{i}} - {ω}_{{b}_{i}} \times {I}_{b} {ω}_{{b}_{i}} ) \cdot Δ t\end{matrix}$$
Where
$${R}_{b}^{w}$$
is rotation of the UAV, m_{b} is mass of the UAV,
$${p}_{b}^{w}$$
is position of the UAV,
$${v}_{b}^{w}$$
is velocity of the UAV, and ω_{b} is angular speed of the UAV, Δt is the period between two contiguous states, Log(*) represent a Logarithmic map of Lie theory, e₃=[0,0,1]^{T}, g is the gravity constant, D is the aerodynamic drag coefficient matrix and
$${ω}_{b}^{\times }$$
represents an operator that spins a 3D vector ω_{b}, T_{b} is resultant thrust, M_{b} is resultant torque, I_{b} is the moment of inertia,
$${R}_{G}^{w}$$
is the gravity vector attitude in the world frame,
$${R}_{w}^{{b}_{i}}$$
is the transpose matrix of
$${R}_{{b}_{i}}^{w} .$$

24. The system of claim 22, wherein the residual of control bound factor h(uⱼ) is derived from a hinge loss cost function E=h(uⱼ) for the control input inequality, which is as follows:
$$\begin{matrix}{E}_{i} = \{ \begin{matrix}{u}_{min}^{j} + {u}_{thr}^{j} - {u}_{j} ( i ) & if {u}_{j} ( i ) < {u}_{min}^{j} + {u}_{thr}^{j} \\ {u}_{j} ( i ) - {u}_{max}^{j} + {u}_{thr}^{j} & if {u}_{max}^{j} - {u}_{thr}^{j} \leq {u}_{j} ( i ) \\ 0 & otherwise\end{matrix} \begin{matrix} \\ \end{matrix} \\ ( 1 \leq i \leq K )\end{matrix}$$
where
$${u}_{min}^{j}$$
is an input lower bound, and
$${u}_{max}^{j}$$
is an input upper bound, and
$${u}_{t h r}^{j}$$
is a threshold value, Qₗᵢₘ is a control bound factor's weighting matrix which determines how fast the error grows as the value approaches the limit, and uⱼ represents the angular speed of the j-th motor of the UAV.

25. A non-transitory computer-readable medium storing instructions that, when executed by a processor, cause the processor to perform the method of claim 1.
